(19) United States
(12) Patent Application Publication
(10) Pub. No.: US 2024/0338561 A1
(43) Pub. Date: Oct. 10, 2024

(54) VERIFICATION OF NEURAL NETWORKS AGAINST LVM-ENCODED PERTURBATIONS IN LATENT SPACE

(71) Applicant: SAFE INTELLIGENCE AI, London (GB)

(72) Inventors: Harleen Hanspal, London (GB); Alessio Lomuscio, London (GB)

(21) Appl. No.: 18/628,433

(22) Filed: Apr. 5, 2024

Related U.S. Application Data
(60) Provisional application No. 63/494,246, filed on Apr. 5, 2023.

(51) Int. Cl. G06N 3/08; G06N 3/0455

(52) U.S. Cl. CPC G06N 3/08; G06N 3/0455

(57) ABSTRACT

Disclosed are techniques for verifying a network against perturbations in a latent space. A method can include receiving input that includes a user model, training an encoding head and a decoder of a verification model based on the input, and extracting features from the user model using a feature detection network of the verification model. The method can further include mapping the extracted features into a latent space, generating one or more latent space specifications including latent vectors corresponding to data points for which to verify the user model, performing a verification process on the mapped features in the latent space mapping to determine robustness of the user model, receiving, as output from the verification process, an indication of robustness of the user model, and generating, based on the indication of robustness not satisfying one or more robustness criteria, counterexamples for the user model using the trained decoder.

### CROSS-REFERENCE TO RELATED APPLICATION

This application claims priority to and the benefit of U.S. Provisional Patent Application No. 63/494,246, entitled “Efficient and Precise Verification of Neural Networks against LVM-encoded Perturbations in the Latent Space,” filed Apr. 5, 2023, the content of which is incorporated by reference herein in its entirety.

### TECHNICAL FIELD

This disclosure generally describes devices, systems, and methods related to verifying models, such as neural networks, against perturbations in latent space.

### BACKGROUND

Systems built on neural networks may be fragile to various perturbations, including small perturbations in the networks' inputs. For example, some systems may fail if slight noise or a slight change in color are added to one or more images in an input dataset. This can be problematic in safety-critical applications, including but not limited to aviation, autonomous vehicles, medical applications, and/or whenever the system's behavior may be required to be robust.

Verification methods for neural networks can be used to check that a given network's behavior is compliant with respect to a safety specification. Specifications are mathematically expressed as constraints on input and output of the network, such as a model, and may express required system properties, such as robustness to norm-bounded perturbations, geometric changes, bias-field changes, etc.

In addition to the above mentioned perturbations, safety critical systems may require high confidence against more complex input perturbations, such as, but not limited to, changes in scene semantics, object or viewpoint pose changes, and/or changes in object characteristics. Modeling these perturbations in the input space can be problematic. These perturbations may be learned from data by using generative models.

Existing methods for verification of specifications defined in latent manifolds can prepend a generative model to the network under consideration, and verify the combined network consisting of a generator/decoder and the original network to be verified. This prepending of a generative model as an independent input set generator for verifying a network can result in the following features: the network can be verified only against images appropriately mapped by the encoder; the network can be verified against reconstructions of the decoder; and the input set can be propagated through both the decoder and the network to be verified. These features, however, can result in a number of limitations associated with existing methods. For example, existing methods can be potentially loose (e.g., not all latent inputs captured in an encoding set may map back to an intended region in primal space) and incomplete (e.g., not all of the intended region in the primal space may map into the set encoded in the latent space). By way of further example, reconstructions and obtained counterexamples may be of poorer quality in terms of sharpness, compared to original datasets for the network/model. This can impair reliability and accuracy of a verification pipeline. By way of a further example, existing architectures may also require high computational effort for the verification step, resulting in large models not being verifiable using the existing pipeline architecture.

Accordingly, there is a need for ways to verify large models and networks against complex perturbations.

### SUMMARY

The disclosure generally describes technology for an invertible encoder-based pipeline to use in verifying latent space sets for neural networks and other types of models. The disclosed technology can be used to verify robustness of models in latent space. For example, the pipeline described herein can be used to verify possible changes that may occur in a neighborhood of model input and assess whether the model is robust to understand and take in those changes to the model input without losing accuracy and without failing. Such changes to the model input can include, but are not limited to, rotations in space (e.g., three-dimensional (3D) rotations) and/or object detection with respect to changes in backgrounds (e.g., color, pattern, lighting). The disclosed technology can provide improved computational efficiency and relative independence to input dimensionality in comparison to other verification pipelines. The disclosed technology can also provide precise counterexamples with high recall and verification outcomes' independence to a decoder in the pipeline. Moreover, the disclosed technology may provide incremental and off-the-shelf verification for a variety of different architectures.

In brief, the disclosed technology can be used to establish whether a model is robust with respect to perturbations (e.g., particular features, 3D rotations) in latent space. If the model is identified as not being robust against those perturbations, the disclosed technology can identify weaknesses of the model in the latent space, and may reconstruct those weaknesses using a decoder to generate counterexamples. Those counterexamples may be used by a relevant user to improve their model, thereby improving robustness and accuracy of the model as well.

The disclosed systems, methods, and techniques can be used to derive specifications capturing scene changes, including, but not limited to, object 3D changes, occlusions, background changes, and/or attribute changes (e.g., hair, gender, skin tone), by identifying appropriate areas in a latent manifold of a defined neural network. The disclosed techniques can also be used to automatically verify the network's specification, including robustness, against a continuum of possible variations captured by variations in the learned latent manifold. These operations can be performed efficiently and with minimum computing overhead, thereby scaling to models with various tunable parameters (hundreds, thousands, millions, etc. of tunable parameters).

In this disclosure, three (3) classes of latent space specifications are discussed, each capturing different types of realistic input variations such as spatial pose, viewpoint, and semantic attribute changes in vision inference tasks. The disclosed techniques introduce measures to evaluate precision of these three (3) classes of specifications in capturing intended variations. The three (3) classes of specifications are merely illustrative examples and thus the disclosed techniques are not limited to only those. The disclosed techniques can also be applicable to other types of specifications for various types of networks and models.

One or more embodiments described herein includes a method for verifying a network against perturbations in a latent space that includes receiving, by a computer system, input including a user model, and training, by the computer system, an encoding head and a decoder of a verification model based, at least in part, on the received input. The method further includes extracting, by the computer system, features from the user model using a feature detection network (FDN) of the verification model, and mapping, by the computer system, and based on applying the trained encoding head of the verification model, the extracted features into a latent space. Still further, the method includes generating, by the computer system, and based on the latent space mapping, one or more latent space specifications that can include latent vectors corresponding to data points for which to verify the user model, and performing, by the computer system, and based on applying the verification model, a verification process on the mapped features in the latent space mapping to determine robustness of the user model. Additionally, the method includes receiving, by the computer system, and as output from performing the verification process, an indication of robustness of the user model, the indication of robustness including a deterministic guarantee of robustness of the user model to inputs captured by the one or more latent space specifications, and determining, by the computer system, whether the indication of robustness of the user model satisfies one or more robustness criteria. Still further, the methods includes generating, by the computer system, and based on a determination that the indication of robustness of the user model does not satisfy the one or more robustness criteria, counterexamples for the user model based, at least in part, on applying the trained decoder of the verification model, with the counterexamples corresponding to a vulnerability of the user model from the inputs captured by the one or more latent space specifications, and returning, by the computer system, at least one of the indication of robustness of the user model or the counterexamples.

In some implementations, the embodiments described herein can optionally include one or more of the following features. For example, the specification input can include at least one Region specification, and/or at least one Segment specification, and/or at least one Axis specification. The specification input can be based on invariance-to-changes-in-an-object-of-interest of the encoding network in input to the user model. invariance-to-changes-in-an-object-of-interest of the encoding network can include non-planar transformations of the object of interest in the input to the user model, and/or semantic changes of the object of interest in the input to the user model, and/or arbitrary task-orthogonal variations of the input to the user model.

The action of extracting, by the computer system, features from the user model using a feature detection network (FDN) of the verification model can include identifying initial layers of the user model and a task head. The verification process can include, by way of example, an inverse of the trained encoding head and the task head of the user model. The user model can include a deep neural network. The verification model can include Latent Variable Model (LVM) and/or a diffusion model. The encoding head can be invertible for at least a portion of a depth of the encoding head. The latent space can be configured to be queried by the trained decoder of the verification model. In at least some instances, the action of generating, by the computer system, and based on a determination that the indication of robustness of the user model does not satisfy the one or more robustness criteria, counterexamples for the user model based on applying the trained decoder of the verification model can include receiving, as output from the verification model, a latent space counterexample, and mapping, using the trained decoder of the verification model, the latent space counterexample to a corresponding dataspace.

One or more embodiments described herein include a system for verifying a network against perturbations in a latent space. The system includes a computer system that can be configured to perform operations. These operations include receiving input including a user model, training an encoding head and a decoder of a verification model based, at least in part, on the received input, and extracting features from the user model using a feature detection network (FDN) of the verification model. The operations further include mapping, based on applying the trained encoding head of the verification model, the extracted features into a latent space, generating, based on the latent space mapping, one or more latent space specifications that can include latent vectors corresponding to data points for which to verify the user model, and performing, based on applying the verification model, a verification process on the mapped features in the latent space mapping to determine robustness of the user model. Still further, the operations include receiving, as output from performing the verification process, an indication of robustness of the user model, the indication of robustness including a deterministic guarantee of robustness of the user model to inputs captured by the one or more latent space specifications, determining whether the indication of robustness of the user model satisfies one or more robustness criteria, and generating, based on a determination that the indication of robustness of the user model does not satisfy the one or more robustness criteria, counterexamples for the user model based, at least in part, on applying the trained decoder of the verification model. The counterexamples correspond to a vulnerability of the user model from the inputs captured by the one or more latent space specifications. Additionally, the operations include returning at least one of the indication of robustness of the user model or the counterexamples.

The system can optionally include one or more of the abovementioned features. Additionally, or alternatively, the system can optionally include one or more of the following features. For example, the specification input can include at least one of a Region specification, a Segment specification, and/or an Axis specification. The encoding head can be invertible for at least a portion of a depth of the encoding head. The operation of generating, based on a determination that the indication of robustness of the user model does not satisfy the one or more robustness criteria, counterexamples for the user model based on applying the trained decoder of the verification model can include receiving, as output from the verification model, a latent space counterexample, and mapping, using the trained decoder of the verification model, the latent space counterexample to a corresponding dataspace.

The devices, system, and techniques described herein may provide one or more advantages. For example, the disclosed pipeline can realize verification on specifications defined by Latent Variable Models (LVMs). The disclosed techniques can achieve high quality reconstructions. The disclosed techniques are also computationally light and thus scalable to be used for large models (e.g., deeper models, models with significant amounts of neurons and/or layers) and sophisticated model inputs (e.g., larger input datasets, tabular data). The disclosed techniques provide scalability especially in light of deeper neural networks being split at different depths. For example, the disclosed techniques can allow a network that may not be verified end-to-end to be split and verified incrementally. Other verification tools and/or processes, on the other hand, may require a network to be verified end-to-end as a whole, which can often mean that it cannot be verified if the verification technique does not support any of its operations or result in undecided verification outcomes for state-of-the-art (SoA) deep neural networks. Undecided verification outcomes for a verification query may imply an inability to provide either a robustness guarantee or a vulnerability example for that query, which can be undesirable to users associated with the networks. Moreover, the disclosed techniques allow for greater applicability of verification for networks by allowing a split after an unsupported network layer/operations so that the unsupported layer/operations does not feature in a verification path.

Because the disclosed pipeline is scalable and lightweight, it also provides for faster computational completion (seconds to mere minutes of processing) as compared to other verification processes (typically taking several minutes to hours for processing), resulting in quicker turnaround to relevant users about whether their models are verified and robust against perturbations in the latent space. In other words, a verification path using the disclosed techniques becomes shorter as compared to other verification paths so that more verification queries can be solved within less time or within any given time period. The disclosed techniques are further equipped with statistical metrics to quantify precision of specifications against requirements for the LVMs and other types of networks and models (e.g., object detection models, neural networks).

The disclosed techniques also provide independent verified robustness guarantees on quality of decoder reconstructions. Some existing verification pipelines verify a combination of a decoder and an original network to be verified. This causes resulting robustness guarantees on a network to be conditional on the quality of reconstructions by that decoder. For example, if the decoder does not produce desired variations or sharp images, the original network can be unfairly verified as robust to variations that never got passed through it or to images that were not realistic enough. The disclosed pipeline, on the other hand, can avoid such inaccuracies in robustness guarantees at least because it at least verifies the network for features corresponding to the original dataset images.

The details of one or more implementations are set forth in the accompanying drawings and the description below. Other features and advantages will be apparent from the description and drawings, and from the claims.

### BRIEF DESCRIPTION OF THE DRAWINGS

The following Detailed Description references the accompanying drawings, which form a part of this application, and which show, by way of illustration, specific, but not necessarily limiting, example implementations, in which:

FIG. 1 illustrates a verification pipeline for supporting permutations in latent space;

FIG. 2 is a conceptual diagram of a system for verifying a model using the verification pipeline of FIG. 1;

FIG. 3 is a diagram of system components that can be used to perform the disclosed techniques;

FIG. 4 is a flowchart of a process for verifying a model using the verification pipeline of FIG. 1;

FIG. 5A illustrates example reconstructions of model data for region specifications;

FIG. 5B illustrates example reconstructions of model data for segment specifications;

FIG. 6 illustrates example reconstructions of model data for axis specifications; and

FIG. 7 is a schematic diagram that shows an example of a computing device and a mobile computing device.

### DETAILED DESCRIPTION

Certain exemplary embodiments will now be described to provide an overall understanding of the principles disclosed herein. One or more examples of these embodiments are illustrated in the accompanying drawings. Those skilled in the art will understand that the systems and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure. In the present disclosure, like-numbered components of various embodiments generally have similar features when those components are of a similar nature and/or serve a similar purpose, unless otherwise noted or otherwise understood by a person skilled in the art.

This disclosure generally relates to technology and techniques for a pipeline used to verify models (e.g., neural networks, LVMs) against perturbations in latent space.

In the following, N: [symbol] ⁿ→ [symbol] ^{m} can be used to denote a neural network, X_{des}, Z_{des} and Y_{des} can be used to denote an input specification defined in a pixel or data space, the input specification being defined in a lower-dimensional latent space and an output specification, respectively. The input specifications X_{des}, Z_{des} can be dependent on variations, denoted as v, for which a relevant user may intend to capture and verify the network. The output specification Y_{des} can depend, at least in part, on a robustness property, which the relevant user intends to verify whether or not the network satisfies for all inputs captured by the input specification.

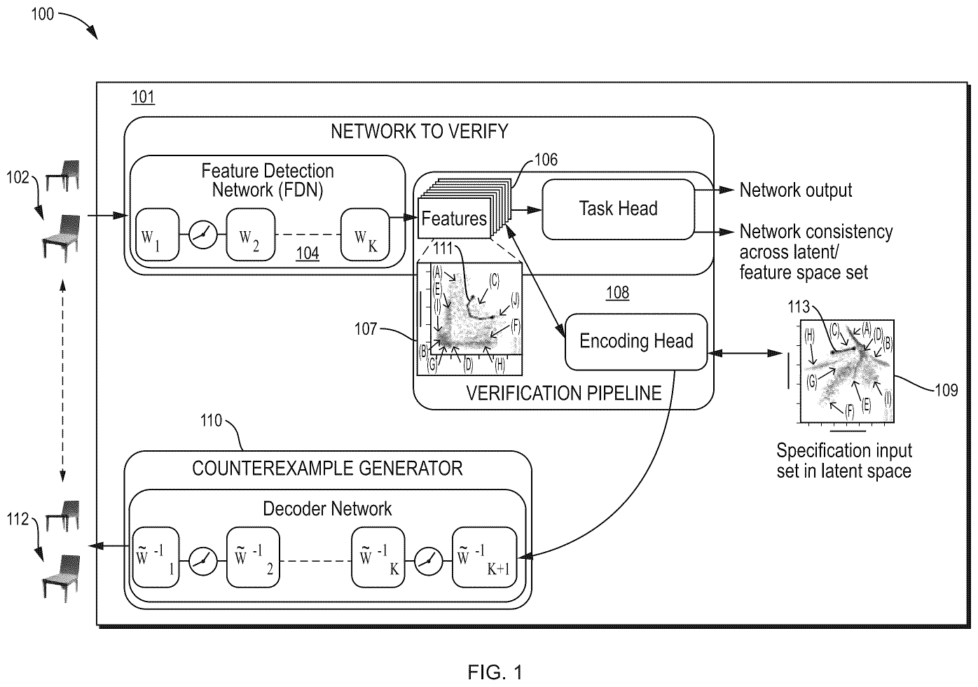

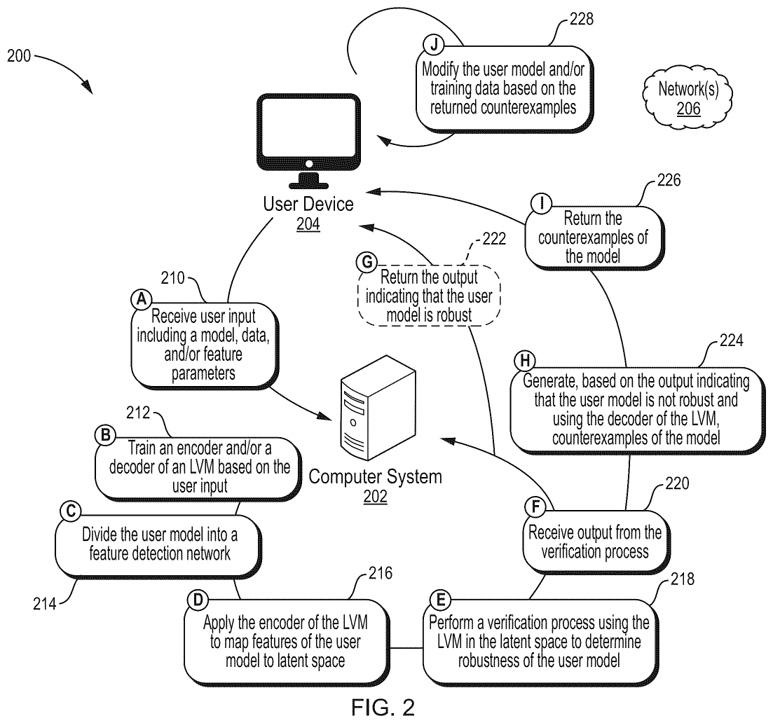

Referring to the figures, FIG. 1 illustrates a verification pipeline 100 for supporting permutations in latent space. The verification pipeline 100 can be executed at a computing device, as described in reference to FIG. 2. The pipeline 100 can be lightweight and scalable for application with models of all sizes. The pipeline 100 can include an LVM 101, built around a network (or other type of machine learning model or system using machine learning) to be verified, that takes the network's intermediate features as its input 102 (block 104). The LVM 101 can be split into a Feature Detection Network (FDN) and a task head. The FDN and the task head can include network layers from a first layer up to a split, and from the split up to a network end, respectively. The individual layers in the network can be denoted by Wₖ within block 104. More particularly, as illustrated, and as appreciated by a person skilled in the art in view of the present disclosures, W₁, W₂ . . . Wₖ represent weights or parameters of the individual network layers, while the illustrated “clocks” (the circles with two hands disposed therein) represent non-linear activation layers in the network, such as the rectified linear unit function (ReLU), which is described in greater detail at https://pytorch.org/docs/stable/generated/torch.nn.ReLU.html, the content of which is incorporated by reference herein in its entirety. Typically, an initial part of the network (e.g., the FDN) executes general feature extraction while later layers (e.g., the task head) of the network process these features to produce outputs required for the intended network task. It can be desired for these outputs to be consistent for all inputs enclosed by the input specification.

The LVM 101's encoder can be invertible and can map the network's input feature set 106 to a spatially coherent latent manifold (e.g., latent space), where the specification input can be defined and a verification process can be performed in latent space (block 108). The input feature set 106 can include intermediate features that can be high-dimensional. The encoder can map a network's unbounded, intermediate features to a more spatially coherent and approximately bounded latent space, where the specification input can be defined. Dimensionality of the latent space can be the same as or similar to dimensionality of the FDN output. The verification backend of the LVM 101 may verify the inverted encoding head and task head. The encoder can be exactly or approximately invertible for its complete depth, including but not limited to for all its layers, a partial depth (e.g., a few of its layers), etc.

The LVM 101 can generate a verification status indicating whether the network is robust/verified for the latent space set with minimal reconstruction overhead. If the network is not robust for the entire latent space set, the verification process also can return one or more counterexamples in the latent space (block 110). Counterexamples can include instances enclosed by the input specification for which the model may produce incorrect output. These latent space counterexamples can be passed through the decoder of the LVM 101 to construct images 112 for which the network is likely to predict incorrectly. These images 112 for which the network may fail to predict correctly can be another useful output of the verification process, and can be used by relevant users for augmenting the original datasets for improved training and testing of the networks. Thus, the decoder may be used for training the LVM 101 and generating the counterexamples.

Although an LVM is described, one or more other types of models and/or networks can also be used to perform the disclosed techniques. As a merely illustrative example, diffusion models may also be used to perform the disclosed techniques/execute the pipeline 100. Various other models can be used so long as they achieve a predetermined threshold level of accuracy with regards to encoding precision of the respective other models.

The pipeline 100 described herein provides one or more advantages. For example, the pipeline 100 provides verification of network features as defined by mappings of original model input data (e.g., images), rather than reconstructed images. The network can also be tested against at least the original images that form a specification basis for the disclosed techniques. Moreover, the pipeline 100 can provide a short verification path, with fewer trivial or undecided verification outcomes. The disclosed pipeline 100 further can provide flexibility on where the network may be split and to use a deep decoder for manifold learning and counterexample generation without negatively impacting verification results. The pipeline 100 can also provide independence with regards to the FDN architecture's depth, type, and/or input dimensionality.

Still referring to FIG. 1, given network N and input-output specification (X_{des}, Y_{des}), a network verification problem can be proposed as a decision problem of determining whether N(x)∈Y_{des}, ∀x∈X_{des}. Here, the Z_{des} is a set in encoder's output space that captures v. To solve this problem, the pipeline 100 in FIG. 1 can be used.

More specifically, to be verified, network N can be received as the input 102 and divided into an FDN (block 104), including N's initial layers and a task head, e.g., a classification or regression head. In this illustrative example, N can be a classifier, but the disclosed techniques apply similarly for other learning tasks. To define a specification, the LVM 101 can be added after the FDN in block 104. The encoder of this LVM 101 can be invertible and can map the intermediate features 106, which is outputted by the FDN, to its latent space where the specification can be defined (block 108). Unlike the feature space, this latent space can be queryable by using the decoder of the LVM 101. The latent space can be made approximately bounded. A verification path with the pipeline 100 can include the inverse of the LVM 101's encoding head and N's task head (see block 108). Verifying block or pipeline 108 can output a verification status indicating whether the network output for all inputs enclosed by the latent space specification is consistently correct or not.

A scatter plot 107 illustrated in the verification block 108 represents a two-dimensional projection of the outputs of the FDN. The output of the FDN is the intermediate features computed by the network until the split. The encoding head then acts on these intermediate features, whose scatter plot 107 is not very well clustered, and transforms them into latent features. This transformation is illustrated by scatter plot 109, in which the outputs are much more clustered as compared to the same data—the raw intermediate network feature/FDN outputs—illustrated in the scatter plot 107. Notably, the plots 107, 109 illustrate two-dimensional projections of multi-dimensional points, and thus not all information will be visible when the outputs include additional dimensions. In the scatter plots 107, 109, the output class labels corresponding to each plot point are denoted by different colors, e.g., (A) red, (B) orange, (C) yellow, (D) green, (E) teal, (F) blue, (G) purple, (H), pink, (I) grey, and (J) brown. As illustrated by comparing plots 107 and 109, the organization of the colored clusters (A)-(J) is much more compact and more representative of the semantics of the points with respect to their class labels. As noted, because the plots 107, 109 are two-dimensional, not all outputs or points will be visible. Thus, as shown in plot 109, the class label (J) brown are not easily visible in the illustration. This merely means that the outputs associated with the class label (J) brown are not visible in the provided top-down two-dimensional projection illustrated in the plot 109, but those outputs would be visible in different projections.

Further, an example specification, or specification line, 113 is plotted in plot 109, and the feature space set this specification corresponds to is plotted as specification, or specification line, 111 in plot 107. The specification 113 can be defined based on the input variations intended to be captured, and more particularly can be defined manually, such as by an individual or group of individuals, automatically, such as by a computer or other processor, or by a combination of the two, i.e., semi-manually or semi-automatically. In the plots 107 and 109 specifically, the more C-shaped curve of the specification 111 is the two-dimensional projection of the intermediate network features, while the specification line 113 is the two-dimensional projection of the latent vectors and an instance of the Segment specifications. By comparing the two specification lines 111, 113, it can be seen that a simple specification in the interpretable, well-clustered latent space (i.e., plot 109) corresponds to semantically meaningful points that could be more spread apart or complicatedly organized in the less interpretable feature space (i.e., plot 107) and, therefore, is more difficult to capture in the absence of the learnt latent space.

This transformation capability for the feature space is provided by the encoding head. The decoder of the LVM 101 may only be used for training the LVM 101, and when the verification status indicates that the network is not robust for a specification, the decoder can act as an image space counterexample generator to provide semantically meaningful images for which the network is likely to predict incorrectly (block 110).

Having formally defined Z_{des} to capture variation v, the problem described above becomes a standard verification problem for a network composed of the inverted encoding head and the original network's task head. This problem can be solved by any standard NN verifier. The invertibility of the encoding head may be necessary to guarantee that the feature vectors that map to Z_{des} can be contained within bounds of the feature space set obtained during verification (block 108). In some implementations, output constraints Y_{des}, may encode invariance of N to v. When the query outcome of block 108 is negative, the verifier/encoder of the LVM 101 can provide a counterexample in Z_{des}, which can then be mapped to a counterexample in input space using the decoder in block 110. The individual network layers of the decoder can be represented by \tilde{W}⁻¹ₖ blocks in block 110. More particularly, as illustrated, and as appreciated by a person skilled in the art in view of the present disclosures, \tilde{W}⁻¹, \tilde{W}⁻¹₂ . . . \tilde{W}⁻¹ₖ, \tilde{W}⁻¹ₖ₊₁ represent weights or parameters of the individual network layers, while the illustrated “clocks” (the circles with two hands disposed therein) represent non-linear activation layers in the network, such as the ReLU, as referenced above with respect to block 104. This can provide an instance of v against which the network is incorrect.

With regards to implementing the pipeline 100, any common LVMs for data generation, such as Variational Auto Encoders (VAEs), Normalizing Flows (NFs), and/or generative adversarial networks (GANs), can be used in the pipeline 100 so long as the FDN of the network to be verified can serve as a backbone of the LVM encoder, and verification backend can verify an inverted encoding head. Given any LVM, Z_{des} can be created in the output space of the LVM encoding head in ways described herein.

VAE can also fit the pipeline 100 well at least because it regularizes the underlying latent space to resemble a prior. This prior (normal, von Mises-Fisher distribution in [symbol] -VAE, [symbol] -VAE) can be light-tailed so that the latent space can be approximately bounded or truncated, and epsilons in the disclosed specification inputs can have limits. However, in VAEs, latent variable z may not be the output of the encoder but a random variable conditioned on its outputs (μ, σ∈ [symbol] _{latent_dim}) by reparameterisation trick. Because this reparameterisation may not be inverted, Z_{des} can be defined for vector [μ, σ] instead of z, with no change in Z_{des}.

For example, as mentioned above, the specification input set Z_{des} for VAEs can be defined using encoding head's outputs \hat{z}=[μ, σ] rather than the latent vector z=μ+∈σ, ∈˜ [symbol] (0,1), which can then be fed to the decoder after reparameterisation. Therefore, valid correspondence between verification outcomes and reconstructions (especially counterexamples) may require that a Z_{des} defined using \hat{z} corresponds to the Z_{des} defined using corresponding z.

To establish the same for Segment queries, the specification input set Z_{des} can be defined as a path between encodings of multiple inputs that should have the same network prediction. Choice of the definition of the path can be arbitrarily chosen by a user to suit his or her intended purpose. One can, for example, define a path as the Shortest Length Path between two inputs, and/or define a more complex path that includes multiple segments or splines based on multiple inputs. As an illustrative and minimal example, consider Z_{des} as the Shortest Length Path joining v₁, v₂, i.e., v̅₁̅v̅₂̅. Every point on \overline{\hat{z}₁\hat{z}₂} lies on z̅₁̅z̅₂̅ can be as follows:

$$\overline{{\hat{z}}_{1} {\hat{z}}_{2}} = ( 1 - α ) [ {μ}_{1} {σ}_{1} ] + α [ {μ}_{2} {σ}_{2} ] , α ∈ [ 0 , 1 ] \qquad ( 1 )$$

$$= [ ( 1 - α ) {μ}_{1} + {αμ}_{2} ( 1 - α ) {σ}_{1} + {ασ}_{2} ] \qquad ( 2 )$$

$$= ( 1 - α ) {μ}_{1} + {αμ}_{2} + ϵ ( ( 1 - α ) {σ}_{1} + {ασ}_{2} ) , ϵ \sim 𝒩 ( 0 , 1 ) \qquad ( 3 )$$

$$= ( 1 - α ) ( {μ}_{1} + {ϵσ}_{1} ) + α ( {μ}_{2} + {ϵσ}_{2} ) \qquad ( 4 )$$

$$= ( 1 - α ) {z}_{1} + α {z}_{2} = \overline{{z}_{1} {z}_{2}} \qquad ( 5 )$$

Therefore, \overline{\hat{z}₁\hat{z}₂} can map to z̅₁̅z̅₂̅ when using a constant E for reparameterisation ((3) above) in the verification phase. The converse may not be true as multiple \overline{\hat{z}₁\hat{z}₂} can generate the same z̅₁̅z̅₂̅ under reparameterisation.

Similarly, Axis and Region queries can also be defined. Axis queries can include a set along a condition axis that is trying to capture and/or toggle aspects, such as particular features appearing in input data (e.g., beards, glasses, hair color). These aspects can be binary, such as accessories, eyeglasses, braces, etc., and/or continuous, such as hair color, beard, smile, age, etc. Region queries can be norm-bounded balls in the latent space that capture variations most commonly occurring in an input dataset. For Axis and Region queries, the Z_{des} can be an epsilon ball that is uniform in all latent dimensions or different per dimension and can be defined using a non-negative reparameterisation constant c as the following:

$$\begin{matrix}\begin{matrix}Z & des ( \hat{z} ) = [ [ μσ\end{matrix} ] - ϵ , [ μσ ] + ϵ ] \\ = [ μ + c σ + ( 1 - c ) ϵ , μ + c σ + ( 1 + c ) ϵ ] \\ ⊇ [ z - ϵ , z + ϵ ] = {Z}_{des ( z )} .\end{matrix}$$

Therefore, under certain conditions for reparameterisation during the verification phase, the proposed specification input sets based on \hat{z} can be the same or a superset of the input sets based on corresponding z.

Differently, GANs may not use an encoder to learn a latent distribution and instead take a prior distribution as input. When GAN is used as the LVM 101, an encoding head can still be added in after the FDN to transform the unconstrained FDN output to a desired prior and define local specifications.

As described above, the pipeline 100 adds an encoding head after the FDN of a network. Typically, a shorter FDN can imply larger latent space dimensionality and verification may involve more network layers.

Two types of feed-forward encoding heads can be used: one includes pairs of an invertible activation and fully-connected (fc) layers; and the other includes alternating affine-coupling layers. The former can be easier to train and may be supported by most network verifiers, but its invertibility to sufficient precision may need to be validated by checking singular values of individual layer weight matrices. An affine-coupling layer can be invertible-by-construction but not supported by standard verifiers. To support its verification, its input dependent scaling and translation unit can be replaced with an input independent learnt vector and an fc layer, respectively. This modified affine-coupling layer can be equivalent to an fc layer in expressiveness, but can have more trainable parameters. The encoding head depth can be increased with the pairs described above until the LVM 101 is considered to be adequately trained and produces good reconstructions. The decoder may allow for a deep upscaling network mirroring the pipeline encoder.

As mentioned above, the pipeline 100 can use an encoding head that includes alternating affine-coupling layers. The alternating affine-coupling layer can be referred to as a bijective mapping f: v→y→z such that:

$$\begin{matrix}{y}_{u} = {v}_{u} \\ {y}_{l} = {v}_{l} ⊙ {e}^{{s}_{1} ( {v}_{u} )} + {t}_{1} ( {v}_{u} ) \\ {z}_{u} = {y}_{u} ⊙ {e}^{{s}_{2} ( {y}_{l} )} + {t}_{2} ( {y}_{l} ) \\ {z}_{l} + {y}_{l} \\ \\ {v}_{u} = {y}_{u} \\ {v}_{l} = ( {y}_{l} - {t}_{1} ( {y}_{u} ) ) ⊙ {e}^{- {s}_{1} ( {v}_{u} )} \\ {y}_{u} = ( {z}_{u} - {t}_{2} ( {z}_{l} ) ) ⊙ {e}^{- {s}_{2} ( {z}_{l} )} \\ {y}_{l} = {z}_{l} ,\end{matrix}$$

where for a vector x, {xᵤ, xₗ} represent its upper and lower halves, i.e., {x[:len(x)/2], x[len(x)/2:]}. With input dependent scaling (s_{*}) and translation (t_{*}) units, which typically can be nonlinear networks, this seemingly affine mapping can learn nonlinearities in input. However, most standard network verifiers may not support this layer, due, at least in part, to input splitting and/or input dependent scaling and/or translation units.

The disclosed technology is an effective use of existing verification backends for verifying deep networks, in which these units can be changed to an input-independent scaling (s_{*}(x)→s_{*}) and an affine translation (t_{*}(x)→W_{*}x+b) units, respectively. This change can make the affine-coupling-layer linear with respect to input and thereby allow standard network verifiers to verify it with minimal modifications, as explained next.

The inverse mapping of the linear version of the affine-coupling layer, f⁻¹ linear, can be simplified to the following:

$$\begin{matrix}{y}_{u} = ( {z}_{u} - {W}_{2} {z}_{l} ) ⊙ {e}^{- {s}_{2}} \\ {y}_{l} = {z}_{l} \\ {v}_{u} = {z}_{u} ⊙ {e}^{- {s}_{2}} - {W}_{2} {z}_{l} ⊙ {e}^{- {s}_{2}} \\ {v}_{l} = ( {y}_{l} - {W}_{1} {y}_{u} ) ⊙ {e}^{- {s}_{1}} \\ = - {W}_{1} {z}_{u} ⊙ {e}^{- ( {s}_{1} + {s}_{2} )} + ( 1 + {W}_{1} {W}_{2} ⊙ {e}^{- {s}_{2}} ) {z}_{l} ⊙ {e}^{- {s}_{1}}\end{matrix} \qquad ( 6 )$$

Further, the f⁻¹ linear mapping above can be implementable using standard fc layer and vector addition operations supported by most available verifiers. When propagating a latent space segment, =0.5,

$$\begin{matrix}\overline{{z}_{1} {z}_{2}} = {z}_{1} + α ( {z}_{2} - {z}_{1} ) = z + α d , & α\end{matrix} ∈ [ 0 , 1 ] ,$$

where z=z₁, d=z₂−z₁, for Segment queries, the inverse mapping f⁻¹ linear can become:

$$\begin{matrix}{y}_{u} = ( {z}_{u} + α {d}_{u} - {W}_{2} ( {z}_{l} + α {d}_{l} ) ) ⊙ {e}^{- {s}_{2}} , \\ = {\underbrace{( {z}_{u} {W}_{2} {z}_{l} ) ⊙ {e}^{- {s}_{2}}}}_{{c}_{1}} + α {\underbrace{( {d}_{u} - {W}_{2} {d}_{l} ) ⊙ {e}^{- {s}_{2}}}}_{{c}_{2}} \\ {y}_{l} = {z}_{l} + α {d}_{l} \\ {v}_{u} = {c}_{1} + α {c}_{2} \\ {v}_{l} = ( {z}_{l} + α {d}_{l} - {W}_{1} ( {c}_{1} + α {c}_{2} ) ) ⊙ {e}^{- {s}_{1}} \\ = {\underbrace{( {z}_{l} - {W}_{1} {c}_{1} ) ⊙ {e}^{- {s}_{1}}}}_{{c}_{3}} + α {\underbrace{( {d}_{l} - {W}_{1} {c}_{2} ) ⊙ {e}^{- {s}_{1}}}}_{{c}_{4}} .\end{matrix} \qquad ( 7 )$$

Thus, propagating back a segment through the last affine-coupling layer of the encoding head can be tight and can output the following line segment, =0.5,

$$\overline{{v}_{1} {v}_{2}} = [ {c}_{1} ( {W}_{2} , {s}_{2} , z ) {c}_{3} ( {W}_{1} , {W}_{2} , {s}_{1} , {s}_{2} , z ) ] + α [ {c}_{2} ( {W}_{2} , {s}_{2} , d ) {c}_{3} ( {W}_{1} , {W}_{2} , {s}_{1} , {s}_{2} , d ) ] \qquad ( 8 )$$

which can be an exact inverse of the input z̅₁̅z̅₂̅ under fₗᵢₙₑₐᵣ. Furthermore, the discussed modifications can make the affine-coupling layer equivalent to an fc layer in expressiveness.

In terms of learning, the presence of more trainable parameters than in an fc layer can make training of this encoding head variant slower than the encoding head using fc layers. With the nonlinear units replaced, the nonlinearity in the encoding head needed to transform the FDN output can be introduced by adding invertible activation layers in between the affine-coupling layer(s). In turn, propagation of Z_{des}, through the inverse of the head is no longer tight beyond the last coupling layer. The inverse for the last affine-coupling layer in the head can be implemented as per Equation (7) above, and the inverse for the earlier coupling layers can be implemented as a high-level module as per Equation (6) above using verification backend's support for fc layer and vector addition operations.

Moreover, the LVM 101 described herein with reference to the pipeline 100 can be trained in a variety of ways. For example, training can be done by using adversarial loss, negative log likelihood, and/or GAN loss. In some implementations, additional training can be performed, including but not limited to conditional training, several loss functions such as (Binary) Cross Entropy, Graphics Code, etc.

With the verification pipeline of the present disclosure well understood, attention can be turned to a system for implementing it. FIG. 2 is a conceptual diagram of a system 200 for verifying a model using the verification pipeline of FIG. 1. In the system 200, a computer system 202 and a user device 204 can communicate (e.g., wired, wirelessly) via network(s) 206.

The computer system 202 can be any type of computing system, computing device, cloud-based system, and/or network of computing devices/systems. The computer system 202 can, in some implementations, be a remote or backend server that is in network communication with the user device 204. The computer system 202 can be configured to perform the techniques described herein, such as using the pipeline of FIG. 1 to verify different types of models, neural networks, and/or deep networks.

The user device 204 can be any type of computing system, including but not limited to a mobile device, a smartphone, a laptop, a server, a tablet, and/or a cloud-based system. The user device 204 can be used by relevant users, such as developers of models (e.g., user models) that are to be passed through the pipeline of FIG. 1. In some implementations, the computer system 202 and the user device 204 can be the same system. In some implementations, the user device 204 can be configured to perform operations of the computer system 202 as described herein. For example, the user device 204 can access and host software and/or a cloud-based service that is configured to deploy the pipeline of FIG. 1 locally at the user device 204 to verify the user's model(s).

Still referring to FIG. 2, the computer system 202 can receive user input indicating a model, data, and/or feature parameters from the user device 204 (block A, 210). The user input can include, for example, a model for which the user desires to verify against perturbations in latent space. The user input can additionally or alternatively include example input data for the model (e.g., images). The user input can additionally or alternatively include parameters indicating the perturbations for which the user desires the model to be verified against (e.g., 3D movements of an object appearing in the input data, changes to color, noise, background, or other aspects of the input data). The user input can include test points that the user desires to check in their model data. For example, the user input can indicate that the user desires to check whether an object detection model can capture a mug in every frame of image data regardless of how that mug is presented in 3D space. As a result, the user input can include still images of the mug.

The computer system 202 can train an encoder and/or a decoder of an LVM based on the user input in block B (212). The encoder and/or the decoder can be trained from the perspective of perturbations to search for, upon which to perform the verification process. Refer to FIG. 1 for further discussion about training the encoder and/or the decoder. The LVM can be used to check the user model against perturbations in latent space, to determine whether the model is sufficiently robust for successful runtime use and application. As described in reference to FIG. 1, the LVM is merely illustrative. Any other type of model and/or network can also be used in the verification pipeline described herein. In some implementations, block B (212) can be performed during or after performing block C (214).

In the above example of testing the object detection model's ability to detect the mug in 3D space, the encoder and the decoder can be trained to represent possible 3D changes of the mug. Accordingly, in block B (212), the encoder and/or the decoder can be trained to work with any type of input and/or features to look for that may be associated with the user model. This allows for the disclosed pipeline to be scalable and usable with various types and sizes of models and other networks.

In block C (214), the computer system can divide the user model into an FDN. Refer to FIG. 1 for further discussion. The user model can be divided into the FDN to identify features of the user model that can be mapped into latent space. In other words, features can be extracted from the user model using the FDN. Those extracted features can then be mapped into a latent feature space, as described below.

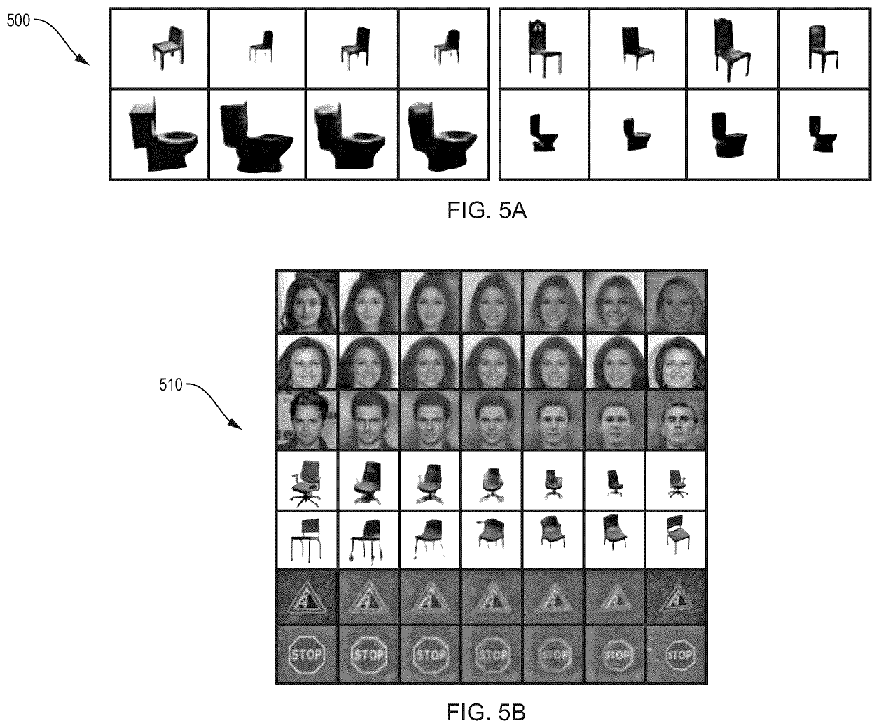

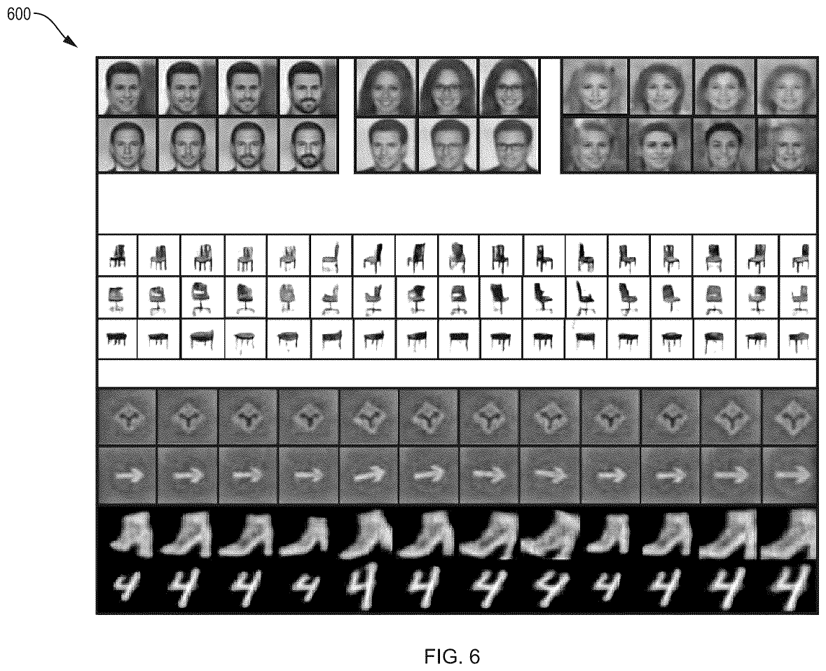

The computer system 202 can then apply the trained encoder of the LVM to map features of the user model to the latent space (block D, 216). For example, the FDM can provide unconstrained output. An encoding head of the LVM can be used to transform such output to a desired prior in the latent space. The encoding head can also be used to define local specifications for performing a verification process of the user model against perturbations in the latent space. Refer to FIG. 1 for further discussion about the specifications, and the discussion later related to FIGS. 5A, 5B, and 6, in which examples are provided.

The computer system 202 can perform a verification process using the LVM in the latent space to determine robustness of the user model (block E, 218). The verification process can be performed according to the feature parameters provided as part of the user input. The feature parameters may indicate perturbations or other aspects for which to verify the user model. Refer to at least FIG. 1 for further discussion about the verification process. For example, the verification process can be performed to assess what happens (e.g., changes) in particular regions of the latent space that the user model may be robust against. In the illustrative example of the object detection model for detecting the mug in 3D space, the verification process can be performed to verify that continuous changes in the representation of the mug in 3D space occur and that the model is robust despite those changes.

Next, the computer system 202 may receive output from the verification process in block F, 220. The output can include indicia (e.g., numeric values, text values, Boolean values) indicating whether the user model is robust or not. When the model is not robust, the output also can include counterexamples for which the network output is inconsistent as evidence of the network's non-robustness. For example, the output can include a formal proof indicating that the model is robust in light of perturbations in the latent space. In the illustrative example of the object detection model for detecting the mug in 3D space, the output can indicate that for a set of 3D changes made to the mug in the latent space (e.g., the perturbations), the model is robust and may still accurately detect and identify the mug.

The verification process can be performed using existing verification techniques to determine whether the model's robustness falls within a predetermined threshold value and/or range. The predetermined threshold value and/or range can be identified by the relevant user (and provided as part of the user input in block A, 210) and/or defined by the computer system 202 (e.g., based on the model parameters, the type of model, the user of the model). If the model's robustness is a value that is within or exceeding the predetermined threshold value and/or range, then the output from the verification process can indicate that the model is sufficiently robust. If, on the other hand, the model's robustness value is less than the predetermined threshold value and/or range, then the output from the verification process can indicate that the model is less than a desired level of robustness.

The computer system 202 can optionally return the output indicating that the user model is robust to the user device 204 (block G, 222). Block G (222) can be performed in scenarios where the verification process returns a model robustness value that is within or exceeding the predetermined threshold value.

On the other hand, the computer system 202 may generate, based on the output indicating that the user model is not robust, counterexamples of the model (block H, 224). The counterexamples of the model can be generated using the trained decoder of the LVM. The decoder can be used to return the user model from the latent space to a primal space, in which the decoder can reconstruct the counterexamples. The counterexamples may represent things that made the model fail the verification process. In the illustrative example of the object detection model for detecting the mug in 3D space, the decoder can generate output (e.g., counterexamples) indicating fragility or weakness of the object detection model in detecting the mug in light of various 3D changes (e.g., perturbations in latent space).

As an illustrative example of generating the counterexamples, a latent space counterexample z*∈Z_{des} can be identified for every unsafe query such that N_{head} ºe⁻¹ (z*) demonstrates non-robustness. However, at least because the LVM decoder is not the exact inverse of its encoder, the decoded counterexample can be spurious, i.e., Nºd(z*) may not be a counterexample. Therefore, every z* can be decoded and labeled as a valid counterexample if its reconstruction can also be a counterexample for the model/network. In the case of a spurious counterexample z*, a local gradient search can be run for a valid counterexample, taking z* as a starting point. In comparison to starting from a mapped vector, this local gradient-based search around z* can take fewer iterations to reach a valid counterexample, and can result in high precision in finding valid and in-domain counterexamples.

Counterexamples aid in network analysis, improvements, dataset augmentation, etc. Therefore, the disclosed techniques can provide latent space counterexamples, which can be mapped to an image space or other dataspace by the decoder. When an outcome of the verification process is non-robust, the verification backend can return a latent space counterexample, which can be mapped to a corresponding dataspace by the decoder. At least because the decoder is not the inverse of the encoder, a local-gradient based search can be performed around the latent space counterexample, which can result in a valid dataspace counterexample. Sometimes, initial verifier-returned counterexamples, when not valid, can be searched around locally to obtain valid counterexamples. In an illustrative example, returned counterexamples can be hazy images, but may be realistic and semantically meaningful images for purposes of improving the underlying network.

The computer system 202 can then return the counterexamples of the model in block I (226) to the user device 204. As described herein, the counterexamples can include instances of an input specification set for the model that may falsify a robustness property for the model. The neural networks have been observed to be vulnerable to changes such as blurry and/or pixelated images, localized semantic changes in the images (e.g., changes in an object's position, orientation, task orthogonal attributes such as its shape, color, accessories, etc.), changes in the object background, changes involving occlusion of key aspects in the image, and/or addition of other objects in the image (e.g., glasses, hat), etc. All these vulnerabilities can be returned as counterexample(s) by the verification process. The counterexamples may include images that negatively impact the model robustness, such as blurry or pixelated images, images in which generate is changed, an object in an image appears in a different position and/or orientation, and/or one or more characteristics and/or additional objects appear in the image (e.g., glasses, hat).

The user device 204 can modify the user model and/or training data for the model based on the returned counterexamples in block J (228). For example, the user device 204 can receive user input to modify the user model, its parameters, and/or its training data based on the provided counterexamples.

In some implementations, the computer system 202 may generate recommendations indicating one or more modifications to the model, its parameters, and/or its training data, which can then be provided to the user device 204. The user device 204 can present the recommendations to the user in a graphical user interface (GUI) display at the user device 204 for review, modification, and/or adoption by the user. The user can then provide user input at the device 204 indicating whether they are adopting and/or modifying the recommendations that were generated by the computer system 202.

Once the user model, its parameters, and/or its training data are modified, the user can provide new user input at the user device 204 for verifying the modified model against the perturbations in the latent space. In other words, one or more of the blocks A-J (210-228) can be iteratively performed, as the user model, its parameters, and/or its training data are updated over time.

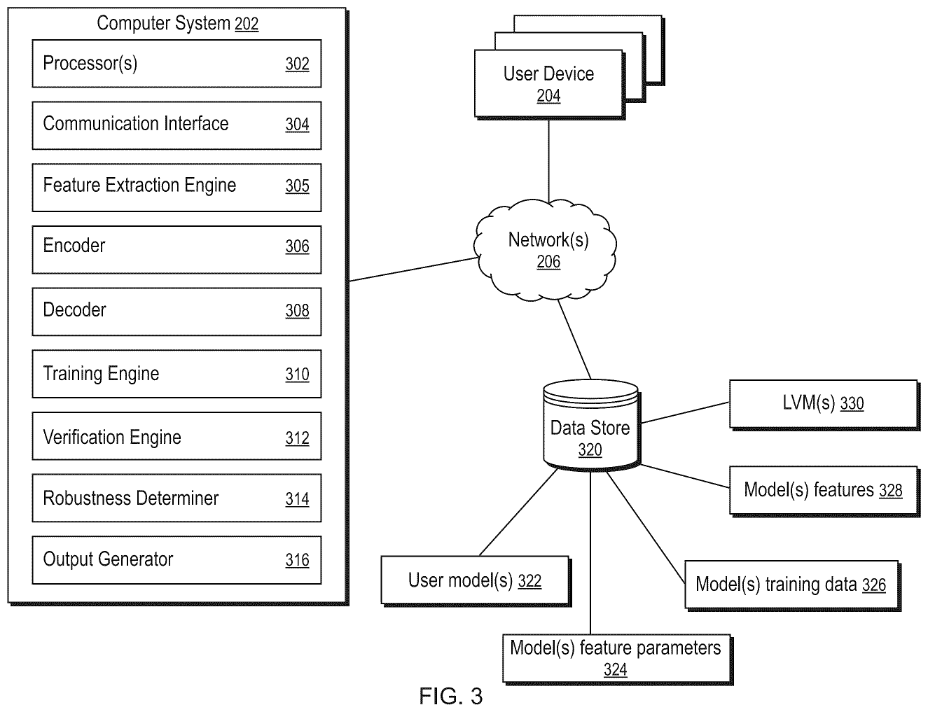

FIG. 3 is a diagram of system components that can be used to perform the disclosed techniques. The computer system 202, the user device(s) 204, and a data store 320 can communicate via the network(s) 206.

The computer system 202 can include one or more processors 302, a communication interface 304, a feature extraction engine 305, an encoder 306, a decoder 308, a training engine 310, a verification engine 312, a robustness determiner 314, and/or an output generator 316. In brief, the processor(s) 302 can be configured to perform any of the disclosed operations according to instructions that are stored and executed by the processor(s) 302. The communication interface 304 can be configured to provide communication between components of the computer system 202 and other components described in FIG. 3.

Any one or more of the components 305, 306, 308, 310, 312, 314, and/or 316 can be modules or components of a model, such as an LVM 330, that is deployed by the computer system 202. Sometimes, the model can be locally deployed at the user device 204, as described further in reference to FIG. 2. The LVM 330 can include the encoder 306, the decoder 308, and/or the verification engine 312. In some implementations, the LVM 330 may include only the encoder 306 and the decoder 308. The verification engine 312 can be part of the computer system 202 and can be configured to apply or otherwise execute the LVM 330 to perform the verification process. In at least some implementations, the LVM 330 can be any other type of model that satisfies one or more accuracy criteria, including but not limited to a diffusion model.

The feature extraction engine 305 can be configured to receive user input from the user device 204 and/or the data store 320 and extract features for use in the verification process. The user input can include a user model(s) 322, model(s) feature parameters 324, model training data 326, and/or model(s) features 328. Refer to FIG. 2 for further discussion about the input. The engine 304 can then employ an FDN to extract relevant features from the user model 322 to be mapped into latent space and checked in the verification process.

The training engine 310 can be configured to train the encoder 306 and/or the decoder 308 based, at least in part, on the user input received from the user device 204 and/or the data store 320. For example, the engine 310 can train the encoder 306 and/or the decoder 308 to identify one or more types of perturbations or other features in latent space for model verification.

The encoder 306 can be configured to receive output from the feature extraction engine 305, such as the extracted features, and map those features into latent space. The encoder 306 can first be trained by the training engine 310 according to the user input. Then the encoder 306 can map the features from the feature extraction engine 305 into the latent space.

The verification engine 312 can be configured to perform verification processes of the user model 322 using the mapping of the features in the latent space. As described in reference to FIGS. 1 and 2, the verification engine 312 can perform the verification process using the LVM 330 to check whether the user model 322 is robust against perturbations in the latent space.

The robustness determiner 314 can be configured to determine whether the user model 322 is robust against the perturbations in the latent space based on the verification process performed by the verification engine 312. In some implementations, the determiner 314 can be part of or a subcomponent of the verification engine 312. The determiner 314 can receive output from the verification engine 312 and determine whether the output satisfies one or more robustness criteria. The one or more robustness criteria can include predetermined threshold value and/or ranges of robustness, as described further in reference to FIG. 2.

The decoder 308 can be configured to generate counterexamples for the user model 322 based on the output from the verification engine 312 and/or the robustness determiner 314. For example, if the robustness determiner 314 determines that the user model 322 is not robust against perturbations in the latent space, the determiner 314 can send a notification to the decoder 308, which can generate the counterexamples. Refer to FIGS. 1 and 2 for further discussion.

The output generator 316 can be configured to generate output for presentation at the user device(s) 204. The output can be generated based on determinations made by the verification engine 312, the robustness determiner 314, and/or the decoder 308. Refer to FIGS. 1 and 2 for further discussion about the output.

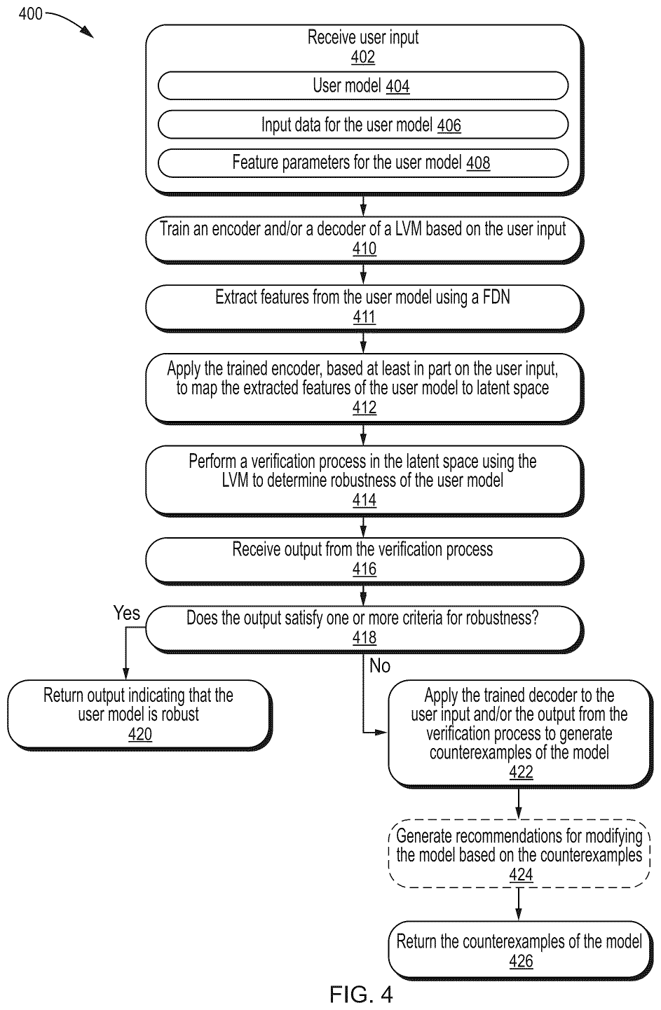

FIG. 4 is a flowchart of a process 400 for verifying a model using the verification pipeline of FIG. 1. The process 400 can be performed by the computer system 202. The process 400 can also be performed by one or more other computing systems, devices, computers, networks, cloud-based systems, and/or cloud-based services, including but not limited to the user device 204. For illustrative purposes, the process 400 is described from the perspective of a computer system.

Referring to the process 400 in FIG. 4, the computer system can receive user input in block 402. The user input can include a user model (e.g., network) in block 404, input data for the user model in block 406, and/or feature parameters for the user model in block 408. Refer to at least block A (210) in FIG. 2 for further discussion.

The computer system can train an encoder and/or a decoder of a LVM based on the user input (block 410). Refer to FIG. 1 and block B (212) in FIG. 2 for further discussion.

In block 411, the computer system can extract features from the user model using an FDN. Refer to at least block 104 in FIG. 1 and block C (214) in FIG. 2 for further discussion.

The computer system can then apply the trained encoder, based at least in part on the user input, to map the extracted features of the user model to latent space (block 412). Refer to block 108 in FIG. 1 and block D (216) in FIG. 2 for further discussion.

Once mapped, the computer system can perform a verification process in the latent space using the LVM to determine robustness of the user model (block 414). The verification process can be performed according to the feature parameters. Refer to block 108 in FIG. 1 and block E (218) in FIG. 2 for further discussion.

The computer system can receive output from the verification process in block 416. Refer to at least block F (220) in FIG. 2 for further discussion.

The computer system can determine whether the output satisfies one or more criteria for robustness in block 418. Refer to FIGS. 2 and 3 for further discussion.

If the one or more criteria is satisfied, the computer system can return output indicating that the user model is robust (block 420). Refer to block G (222) in FIG. 2 for further discussion.

If the one or more criteria is not satisfied in block 418, the computer system can apply the trained decoder to the user input and/or the output from the verification process to generate counterexamples of the user model (block 422). Refer to block 110 in FIG. 1 and block H (224) in FIG. 2 for further discussion.

The computer system may optionally generate recommendations for modifying the user model based on the counterexamples (block 424). Refer to at least FIGS. 2 and 3 for further discussion.

In block 426, the computer system can return at least the counterexamples of the model. Refer to block the output 112 in FIG. 1 and block I (226) in FIG. 2 for further discussion.

### Illustrative Examples

FIG. 5A illustrates example reconstructions 500 of model data for region specifications. Region specifications can refer to norm-bounded balls in latent space that capture variations most commonly occurring in an input dataset. The reconstructions 500 show variations sampled from E-balls around an image encoding. As illustrated, a larger E can capture more varied changes of input received. FIG. 5B illustrates example reconstructions 510 of model data for segment specifications. Segment specifications is a path between encodings of any two (2) inputs, which should have the same network prediction. Middle columns of the reconstructions 510 show reconstructions of input samples from a segment joining encodings of a dataset of images in outer columns. FIG. 6 illustrates example reconstructions 600 of model data for axis specifications. Axis specification is a set along a condition axis that is trying to capture task and/or toggle aspects, such as particular features appearing in input data (e.g., beards, glasses, hair color). In the reconstructions 600, all images are reconstructions and can be seen undergoing changes as specific conditional dimensions may be varied.

Referring to FIGS. 5A, 5B, and 6, the specifications considered herein can focus on encoding network invariance to changes in an object of interest in input for a network (or other type of model), also referred to herein as invariance-to-changes-in-an-object-of-interest or invariance-to-changes-in-an-object-of-interest of an/the encoding network. These changes can include, but are not limited to, non-planar transformations, which can be specific semantic changes of the object and/or its arbitrary task-orthogonal variations commonly occurring in the dataset. Learning tasks and datasets where the objects of interest and their variations are discernible against unimportant content in the input can also be used for such specifications.

A local latent space set Z_{des} against which networks may be verified can be defined arbitrarily. For example, this can defined as Region (see the reconstructions 500 in FIG. 5A), Segment (see the reconstructions 510 in FIG. 5B), and/or Axis (see the reconstructions 600 in FIG. 6). Other inputs in the latent space may also be possible.

Regarding Region specifications or queries, as shown by the reconstructions 500 in FIG. 5A, Z_{des} can be defined as a [symbol] _{∞}-norm ball around an image encoding, i.e., [symbol] ∈(z) {z′∥|z′−e(x)∥_{∞}<∈}. Given a spatially coherent manifold, Z_{des} should capture commonly occurring local variations of an image. For example, with an LVM trained on a 3D objects dataset consisting of images of objects such as chair, table, toilet, etc. with a variety of designs and from different viewpoints, a Region specification can enclose objects with variations, such as in their different views and designs (refer to FIG. 5A) that occur commonly enough in the dataset for the LVM to have learnt them over the course of its training.

The disclosed techniques themselves may be independent of the choice of Z_{des}. Note, moreover, that at least because the specifications may not be guaranteed to be complete by construction in some illustrative examples, Z_{des} can be empirically ascertained to sufficiently capture intended variations using metrics presented herein on specification validity. Also note that local epsilon balls in a sufficiently trained Conditional VAE's latent space may necessarily generate sufficient instances of local input perturbations. This further can validate the use of Axis and Region queries for formal robustness checks and the use of VAEs as the LVM in the disclosed pipeline. The specifications described in reference to FIGS. 5A, 5B, and 6 can also be systematically inspected by means of the sample reconstructions 500, 510, and 600, respectively.

Regarding Segment specifications or queries, as shown by the reconstructions 510 in FIG. 5B, Z_{des} can be defined as a path connecting encodings of two (2) images {x₁, x₂} that differ in intended attributes or transforms (e.g., images of an object with different poses or backgrounds, as shown in the reconstructions 510). Multiple definitions for Z_{des} may also be possible based on a traversal between the pair encodings, such as a maximum likelihood-based traversal, splines using multiple intermediate encodings, etc. With the Shortest Length Path (SLP), an outcome can be Z_{des}=e(x₁)+α(e(x₂)−e(x₁)), α∈[0,1]_{latent_dim}. This Z_{des} can be highly expressive at least because, in general, the image pair can be of any two (2) images whose semantic interpolations should be consistently predicted by a network.

Regarding FIG. 5B, an assumption behind Segment specifications is that semantic interpolations of an image pair map to interpolations of its encoding pair. To validate it, a metric can be defined as a distance of the encodings of the interpolations of an image pair to line segment(s) joining the encodings of that pair. In practice, for validating pose invariance queries, inputs can be generated (e.g., by the computer system 202) with varying extents of a transform, construct a path between the encodings of the image pair with the most extreme mutual transform, and compute distance between the encodings of the intermediate transforms and their projection on this path. The distance can be divided by square-root of latent dimensionality to generalize across manifolds of different dimensions. As an example, the proposed distance between an encoding xᵢ and the Shortest Length Path (SLP) between encodings x₁ and x₂, denoted as vector x̅₁̅₂̅, can be d(xᵢ, proj_{[} x₁₂]xᵢ)/\sqrt{n}, xᵢ={x₁+α(x₂−x₁)}∈ [symbol] ⁿ, α∈[0,1].

Note how this metric can be the latent space-based analogue of the pixel space distance, which can also be used to evaluate generators in an EDN approach. This use of different metrics can be justified at least because the latter evaluates LVM's generation capabilities, which can be critical for EDN-based verification, and the former evaluates spatial coherence of LVM manifold, which can be critical for the disclosed techniques. The second, third, fourth, fifth, and sixth columns in the reconstructions 510 of FIG. 5B show reconstructions of samples from a segment joining latent encodings of the images in the first and seventh columns. Systematic sampling and reconstructions, as shown in the reconstructions 510 of FIG. 5B, can be used to ascertain a spatial coherence of the LVM manifold, and thereby a nature of inputs being enclosed by the input specifications for verification. For example, the reconstructions 510 of FIG. 5B validate that the reconstructions in the second, third, fourth, fifth, and sixth columns vary in a smooth, semantically consistent and realistic manner from the image in the first column to the image in the seventh column.

Regarding Axis specifications or queries, as shown by the reconstructions 600 in FIG. 6, Z_{des} can be defined as a set generated by varying an encoding's disentangled dimensions, such as those trained to capture variations of a specific attribute or a single degree of freedom for pose change. For example, the following may be considered: Z_{des}=[max{zₗ, e(x)ᵢ−∈}, min{e(x)ᵢ+∈, zᵤ}], i∈I_{c}, where I_{c} can be a set of conditional dimension indices and [zₗ, zᵤ] can be limits containing a significant percentile of distribution along these dimensions. Given conditional training, this Z_{des} can capture all variations of an image generated by an attribute or transform change, even when this image has no similar local variations present in the dataset.

Accordingly, supervised conditional training can be used from intermediate network features using (binary) cross entropy loss for discrete attributes and/or as a graphics code for continuous attributes. Systemic qualitative validation of an encoder mapping can also be performed through manifold embeddings and directed reconstructions. For example, all images in an example dataset can be generated from a single image dataset as the encoding is perturbed in the conditioned axis with a non-conditioned axis being fixed and vice versa. The conditioned axis can be verified especially for lower-dimension manifolds for larger extents than the non-conditioned axis. Verifying Axis specifications can prove high invariance to task-orthogonal aspects.

Regarding FIG. 6, motivation behind axis specifications can include disentanglement of conditional dimensions in capturing specific variations. To ascertain disentanglement, the following can be computed: a ratio of a highest value among incorrect conditional dimensions to a value of a correct conditional dimension when verifying against discrete attributes. When trained for continuous transforms, the equivalent metric can be a ratio of variance in correct conditional dimension to maximum variance among incorrect conditional dimensions for normalized encodings. For example, all images featured in FIG. 6 can be reconstructed from a latent embedding of a single image per row. The reconstructions can be seen in FIG. 6 as undergoing targeted changes as the specific conditional dimensions are changed.

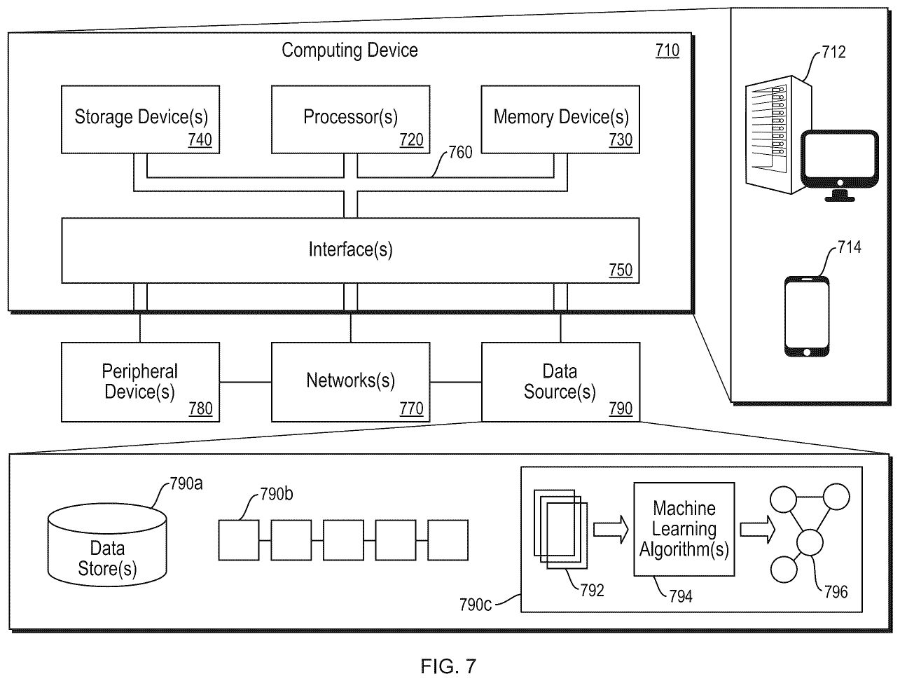

FIG. 7 is a schematic diagram that shows an example of a computing system 700 that can be used to implement the techniques described herein. The computing system 700 includes one or more computing devices (e.g., computing device 710), which can be in wired and/or wireless communication with various peripheral device(s) 780, data source(s) 790, and/or other computing devices (e.g., over network(s) 770). The computing device 710 can represent various forms of stationary computers 712 (e.g., workstations, kiosks, servers, mainframes, edge computing devices, quantum computers, etc.) and mobile computers 714 (e.g., laptops, tablets, mobile phones, personal digital assistants, wearable devices, etc.). In some implementations, the computing device 710 can be included in (and/or in communication with) various other sorts of devices, such as data collection devices (e.g., devices that are configured to collect data from a physical environment, such as microphones, cameras, scanners, sensors, etc.), robotic devices (e.g., devices that are configured to physically interact with objects in a physical environment, such as manufacturing devices, maintenance devices, object handling devices, etc.), vehicles (e.g., devices that are configured to move throughout a physical environment, such as automated guided vehicles, manually operated vehicles, etc.), or other such devices. Each of the devices (e.g., stationary computers, mobile computers, and/or other devices) can include components of the computing device 710, and an entire system can be made up of multiple devices communicating with each other. For example, the computing device 710 can be part of a computing system that includes a network of computing devices, such as a cloud-based computing system, a computing system in an internal network, or a computing system in another sort of shared network. Processors of the computing device (710) and other computing devices of a computing system can be optimized for different types of operations, secure computing tasks, etc. The components shown herein, and their functions, are meant to be examples, and are not meant to limit implementations of the technology described and/or claimed in this document.

The computing device 710 includes processor(s) 720, memory device(s) 730, storage device(s) 740, and interface(s) 750. Each of the processor(s) 720, the memory device(s) 730, the storage device(s) 740, and the interface(s) 750 are interconnected using a system bus 760. The processor(s) 720 are capable of processing instructions for execution within the computing device 710, and can include one or more single-threaded and/or multi-threaded processors. The processor(s) 720 are capable of processing instructions stored in the memory device(s) 730 and/or on the storage device(s) 740. The memory device(s) 730 can store data within the computing device 710, and can include one or more computer-readable media, volatile memory units, and/or non-volatile memory units. The storage device(s) 740 can provide mass storage for the computing device 710, can include various computer-readable media (e.g., a floppy disk device, a hard disk device, a tape device, an optical disk device, a flash memory or other similar solid state memory device, or an array of devices, including devices in a storage area network or other configurations), and can provide date security/encryption capabilities.

The interface(s) 750 can include various communications interfaces (e.g., USB, Near-Field Communication (NFC), Bluetooth, Wi-Fi, Ethernet, wireless Ethernet, etc.) that can be coupled to the network(s) 770, peripheral device(s) 780, and/or data source(s) 790 (e.g., through a communications port, a network adapter, etc.). Communication can be provided under various modes or protocols for wired and/or wireless communication. Such communication can occur, for example, through a transceiver using a radio-frequency. As another example, communication can occur using light (e.g., laser, infrared, etc.) to transmit data. As another example, short-range communication can occur, such as using Bluetooth, Wi-Fi, or other such transceiver. In addition, a GPS (Global Positioning System) receiver module can provide location-related wireless data, which can be used as appropriate by device applications. The interface(s) 750 can include a control interface that receives commands from an input device (e.g., operated by a user) and converts the commands for submission to the processors 720. The interface(s) 750 can include a display interface that includes circuitry for driving a display to present visual information to a user. The interface(s) 750 can include an audio codec which can receive sound signals (e.g., spoken information from a user) and convert it to usable digital data. The audio codec can likewise generate audible sound, such as through an audio speaker. Such sound can include real-time voice communications, recorded sound (e.g., voice messages, music files, etc.), and/or sound generated by device applications.

The network(s) 770 can include one or more wired and/or wireless communications networks, including various public and/or private networks. Examples of communication networks include a LAN (local area network), a WAN (wide area network), and/or the Internet. The communication networks can include a group of nodes (e.g., computing devices) that are configured to exchange data (e.g., analog messages, digital messages, etc.), through telecommunications links. The telecommunications links can use various techniques (e.g., circuit switching, message switching, packet switching, etc.) to send the data and other signals from an originating node to a destination node. In some implementations, the computing device 710 can communicate with the peripheral device(s) 780, the data source(s) 790, and/or other computing devices over the network(s) 770. In some implementations, the computing device 710 can directly communicate with the peripheral device(s) 780, the data source(s), and/or other computing devices.

The peripheral device(s) 780 can provide input/output operations for the computing device 710. Input devices (e.g., keyboards, pointing devices, touchscreens, microphones, cameras, scanners, sensors, etc.) can provide input to the computing device 710 (e.g., user input and/or other input from a physical environment). Output devices (e.g., display units such as display screens or projection devices for displaying graphical user interfaces (GUIs)), audio speakers for generating sound, tactile feedback devices, printers, motors, hardware control devices, etc.) can provide output from the computing device 710 (e.g., user-directed output and/or other output that results in actions being performed in a physical environment). Other kinds of devices can be used to provide for interactions between users and devices. For example, input from a user can be received in any form, including visual, auditory, or tactile input, and feedback provided to the user can be any form of sensory feedback (e.g., visual feedback, auditory feedback, or tactile feedback).

The data source(s) 790 can provide data for use by the computing device 710, and/or can maintain data that has been generated by the computing device 710 and/or other devices (e.g., data collected from sensor devices, data aggregated from various different data repositories, etc.). In some implementations, one or more data sources can be hosted by the computing device 710 (e.g., using the storage device(s) 740). In some implementations, one or more data sources can be hosted by a different computing device. Data can be provided by the data source(s) 790 in response to a request for data from the computing device 710 and/or can be provided without such a request. For example, a pull technology can be used in which the provision of data is driven by device requests, and/or a push technology can be used in which the provision of data occurs as the data becomes available (e.g., real-time data streaming and/or notifications). Various sorts of data sources can be used to implement the techniques described herein, alone or in combination.

In some implementations, a data source can include one or more data store(s) 790a. The database(s) can be provided by a single computing device or network (e.g., on a file system of a server device) or provided by multiple distributed computing devices or networks (e.g., hosted by a computer cluster, hosted in cloud storage, etc.). In some implementations, a database management system (DBMS) can be included to provide access to data contained in the database(s) (e.g., through the use of a query language and/or application programming interfaces (APIs)). The database(s), for example, can include relational databases, object databases, structured document databases, unstructured document databases, graph databases, and other appropriate types of databases.

In some implementations, a data source can include one or more blockchains 790b. A blockchain can be a distributed ledger that includes blocks of records that are securely linked by cryptographic hashes. Each block of records includes a cryptographic hash of the previous block, and transaction data for transactions that occurred during a time period. The blockchain can be hosted by a peer-to-peer computer network that includes a group of nodes (e.g., computing devices) that collectively implement a consensus algorithm protocol to validate new transaction blocks and to add the validated transaction blocks to the blockchain. By storing data across the peer-to-peer computer network, for example, the blockchain can maintain data quality (e.g., through data replication) and can improve data trust (e.g., by reducing or eliminating central data control).

In some implementations, a data source can include one or more machine learning systems 790c. The machine learning system(s) 790c, for example, can be used to analyze data from various sources (e.g., data provided by the computing device 710, data from the data store(s) 790a, data from the blockchain(s) 790b, and/or data from other data sources), to identify patterns in the data, and to draw inferences from the data patterns. In general, training data 792 can be provided to one or more machine learning algorithms 794, and the machine learning algorithm(s) can generate a machine learning model 796. Execution of the machine learning algorithm(s) can be performed by the computing device 710, or another appropriate device. Various machine learning approaches can be used to generate machine learning models, such as supervised learning (e.g., in which a model is generated from training data that includes both the inputs and the desired outputs), unsupervised learning (e.g., in which a model is generated from training data that includes only the inputs), reinforcement learning (e.g., in which the machine learning algorithm(s) interact with a dynamic environment and are provided with feedback during a training process), or another appropriate approach. A variety of different types of machine learning techniques can be employed, including but not limited to convolutional neural networks (CNNs), deep neural networks (DNNs), recurrent neural networks (RNNs), and other types of multi-layer neural networks.

Various implementations of the systems and techniques described herein can be realized in digital electronic circuitry, integrated circuitry, specially designed ASICs (application specific integrated circuits), computer hardware, firmware, software, and/or combinations thereof. A computer program product can be tangibly embodied in an information carrier (e.g., in a machine-readable storage device), for execution by a programmable processor. Various computer operations (e.g., methods described in this document) can be performed by a programmable processor executing a program of instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, by a computer to perform a certain activity or bring about a certain result. A computer program can be written in any form of programming language, including compiled or interpreted languages, and can be deployed in any form, including as a stand-alone program or as a module, component, subroutine, or other unit suitable for use in a computing environment. A computer program product can be a computer- or machine-readable medium, such as a storage device or memory device. As used herein, the terms machine-readable medium and computer-readable medium refer to any computer program product, apparatus and/or device (e.g., magnetic discs, optical disks, memory, etc.) used to provide machine instructions and/or data to a programmable processor, including a machine-readable medium that receives machine instructions as a machine-readable signal. The term machine-readable signal refers to any signal used to provide machine instructions and/or data to a programmable processor.

Suitable processors for the execution of a program of instructions include, by way of example, both general and special purpose microprocessors, and can be a single processor or one of multiple processors of any kind of computer. Generally, a processor will receive instructions and data from a read-only memory or a random access memory or both. The elements of a computer are a processor for executing instructions and one or more memory devices for storing instructions and data. Generally, a computer can also include, or can be operatively coupled to communicate with, one or more mass storage devices for storing data files. Such devices can include magnetic disks (e.g., internal hard disks and/or removable disks), magneto-optical disks, and optical disks. Storage devices suitable for tangibly embodying computer program instructions and data can include all forms of non-volatile memory, including by way of example semiconductor memory devices, flash memory devices, magnetic disks (e.g., internal hard disks and removable disks), magneto-optical disks, and optical disks. The processor and the memory can be supplemented by, or incorporated in, ASICs (application-specific integrated circuits).

The systems and techniques described herein can be implemented in a computing system that includes a back end component (e.g., a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). The computer system can include clients and servers, which can be generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A method for verifying a network against perturbations in a latent space, the method comprising:
receiving, by a computer system, input comprising a user model;
training, by the computer system, an encoding head and a decoder of a verification model based, at least in part, on the received input;
extracting, by the computer system, features from the user model using a feature detection network (FDN) of the verification model;
mapping, by the computer system, and based on applying the trained encoding head of the verification model, the extracted features into a latent space;
generating, by the computer system, and based on the latent space mapping, one or more latent space specifications that comprise latent vectors corresponding to data points for which to verify the user model;
performing, by the computer system, and based on applying the verification model, a verification process on the mapped features in the latent space mapping to determine robustness of the user model;
receiving, by the computer system, and as output from performing the verification process, an indication of robustness of the user model, wherein the indication of robustness comprises a deterministic guarantee of robustness of the user model to inputs captured by the one or more latent space specifications;
determining, by the computer system, whether the indication of robustness of the user model satisfies one or more robustness criteria;
generating, by the computer system, and based on a determination that the indication of robustness of the user model does not satisfy the one or more robustness criteria, counterexamples for the user model based, at least in part, on applying the trained decoder of the verification model, wherein the counterexamples correspond to a vulnerability of the user model from the inputs captured by the one or more latent space specifications; and
returning, by the computer system, at least one of the indication of robustness of the user model or the counterexamples.

2. The method of claim 1, wherein the specification input comprises at least one Region specification.

3. The method of claim 1, wherein the specification input comprises at least one Segment specification.

4. The method of claim 1, wherein the specification input comprises at least one Axis specification.

5. The method of claim 1, wherein the specification input is based on invariance-to-changes-in-an-object-of-interest of an encoding network in input to the user model.

6. The method of claim 5, wherein the invariance-to-changes-in-an-object-of-interest of the encoding network comprises non-planar transformations of the object of interest in the input to the user model.

7. The method of claim 5, wherein the invariance-to-changes-in-an-object-of-interest of the encoding network comprises semantic changes of the object of interest in the input to the user model.

8. The method of claim 5, wherein the invariance-to-changes-in-an-object-of-interest of the encoding network comprises arbitrary task-orthogonal variations of the input to the user model.

9. The method of claim 1, wherein extracting, by the computer system, features from the user model using a feature detection network (FDN) of the verification model comprises identifying initial layers of the user model and a task head.

10. The method of claim 9, wherein the verification process comprises an inverse of the trained encoding head and the task head of the user model.

11. The method of claim 1, wherein the user model comprises a deep neural network.

12. The method of claim 1, wherein the verification model comprises Latent Variable Model (LVM).

13. The method of claim 1, wherein the verification model comprises a diffusion model.

14. The method of claim 1, wherein the encoding head is invertible for at least a portion of a depth of the encoding head.

15. The method of claim 1, wherein the latent space is configured to be queried by the trained decoder of the verification model.

16. The method of claim 1, wherein generating, by the computer system, and based on a determination that the indication of robustness of the user model does not satisfy the one or more robustness criteria, counterexamples for the user model based on applying the trained decoder of the verification model comprises:
receiving, as output from the verification model, a latent space counterexample; and
mapping, using the trained decoder of the verification model, the latent space counterexample to a corresponding dataspace.

17. A system for verifying a network against perturbations in a latent space, the system comprising:
a computer system that is configured to perform operations comprising:
receiving input comprising a user model;
training an encoding head and a decoder of a verification model based, at least in part, on the received input;
extracting features from the user model using a feature detection network (FDN) of the verification model;
mapping, based on applying the trained encoding head of the verification model, the extracted features into a latent space;
generating, based on the latent space mapping, one or more latent space specifications that comprise latent vectors corresponding to data points for which to verify the user model;
performing, based on applying the verification model, a verification process on the mapped features in the latent space mapping to determine robustness of the user model;
receiving, as output from performing the verification process, an indication of robustness of the user model, wherein the indication of robustness comprises a deterministic guarantee of robustness of the user model to inputs captured by the one or more latent space specifications;
determining whether the indication of robustness of the user model satisfies one or more robustness criteria;
generating, based on a determination that the indication of robustness of the user model does not satisfy the one or more robustness criteria, counterexamples for the user model based, at least in part, on applying the trained decoder of the verification model, wherein the counterexamples correspond to a vulnerability of the user model from the inputs captured by the one or more latent space specifications; and
returning at least one of the indication of robustness of the user model or the counterexamples.

18. The system of claim 17, wherein the specification input comprises at least one of a Region specification, a Segment specification, or an Axis specification.

19. The system of claim 17, wherein the encoding head is invertible for at least a portion of a depth of the encoding head.

20. The system of claim 17, wherein generating, based on a determination that the indication of robustness of the user model does not satisfy the one or more robustness criteria, counterexamples for the user model based on applying the trained decoder of the verification model comprises:
receiving, as output from the verification model, a latent space counterexample; and
mapping, using the trained decoder of the verification model, the latent space counterexample to a corresponding dataspace.
